(19) United States
(12) Patent Application Publication
(10) Pub. No.: US 2012/0268045 A1
(43) Pub. Date: Oct. 25, 2012

(54) METHOD AND APPARATUS FOR BRAKING AN ELECTRIC MOTOR

(76) Inventor: Omar Eyas Abdel Rahim El-Qawasmeh, Irbid (JO)

(21) Appl. No.: 13/093,836

(22) Filed: Apr. 25, 2011

(51) Int. Cl. H02P 3/14

(52) U.S. Cl. 318/376

(57) ABSTRACT

The invention provides a method and apparatus for braking an electric motor. The apparatus includes an electric motor, an electric generator, and an electrical circuit arrangement capable of connecting the electric generator to the electric motor. The electric generator generates an instantaneous generator electromotive force at substantially equal magnitude and opposite polarity to an instantaneous motor electromotive force present in the electric motor. The electrical circuit arrangement is capable of supplying the instantaneous generator electromotive force to the electric motor. The instantaneous generator electromotive force is supplied in response to connecting the electric generator and the electric motor. The instantaneous generator electromotive force substantially negates the instantaneous motor electromotive force, thereby braking the electric motor.

### FIELD OF THE INVENTION

The invention in general, relates t0 braking an electric motor, and more specifically, to a method and apparatus for braking an electric motor by substantially negating an instantaneous motor electromotive force generated by the electric motor.

### BACKGROUND OF THE INVENTION

Electric motors are used in a variety of applications, including machine tools, robotic arms, vehicles, earth movers, heavy-duty machines, trains, etc. Considering an example of an electric vehicle, an electric motor is a fundamental component of a power train of the electric vehicle. Among other functions, the electric motor is a source of power and torque.

The electric motor may be, for example operated to produce a positive torque for operating machines in a motoring mode. These machines may include braking mechanisms that may be used to generate frictional forces opposite to the direction of movement of parts of the machines for stopping the movement of these parts. However, these frictional forces generated may lead to wear and tear of the parts of the machines. For example, in order to decelerate a vehicle, the vehicle is equipped with one or more mechanisms in its power train that when operated are capable of applying a load on the power train. These mechanisms include wheel brakes that apply frictional forces to wheels during rotation, thus creating a torque that opposes rotation of the wheels. This torque creates forces at the interfaces between the wheels' tires and road surface opposing the direction of vehicle motion, thereby decelerating the vehicle. However, the frictional forces that act on the rotating wheels generate heat that raises brake temperature. The heat and wear created by applications of the brakes multiple times eventually degrade brake linings or brake pads, necessitating their replacement. Further, as a result of this degradation of the brake linings the deceleration of the vehicle tends to become ineffective. There may be a delay between an instant where brakes are applied and an instant where the vehicle is eventually stopped. This ineffective deceleration of the vehicle may be hazardous to pedestrians, thus causing many accidents.

Therefore, there is a need for a method and apparatus for braking an electric motor by substantially reflecting a polarity of an instantaneous motor electromotive force generated by the electric motor. Additionally there is a need for the braking of the electric motor to be frictionless.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an apparatus for braking an electric motor in accordance with an embodiment of the invention.

FIG. 2 illustrates a system for braking an electric motor connected to one or more wheels mounted on a shaft in accordance with an embodiment of the invention.

FIG. 3 illustrates a system for braking an electric motor connected to one or more wheels mounted on a shaft in accordance with another embodiment of the invention.

FIG. 4 is a flowchart of a method of braking an electric motor in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus for braking an electric motor by substantially reflecting a polarity of an instantaneous motor electromotive force generated by the electric motor. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, or apparatus that comprises a list of elements does not include only those elements but may include other elements not expressly listed or inherent to such process, method, or apparatus. An element proceeded by “comprises . . . a” does not, without more constraints, preclude the existence of additional identical elements in the process, method, or apparatus that comprises the element.

Various embodiments of the invention provide a method and apparatus for braking an electric motor. The apparatus includes an electric motor, an electric generator, and an electrical circuit arrangement capable of connecting the electric generator to the electric motor. The electric generator generates an instantaneous generator electromotive force at substantially equal magnitude and opposite polarity to an instantaneous motor electromotive force present in the electric motor. The electrical circuit arrangement is capable of supplying the instantaneous generator electromotive force to the electric motor. The instantaneous generator electromotive force is supplied in response to connecting the electric generator and the electric motor. The instantaneous generator electromotive force substantially negates the instantaneous motor electromotive force generated by the electric motor, thereby braking the electric motor.

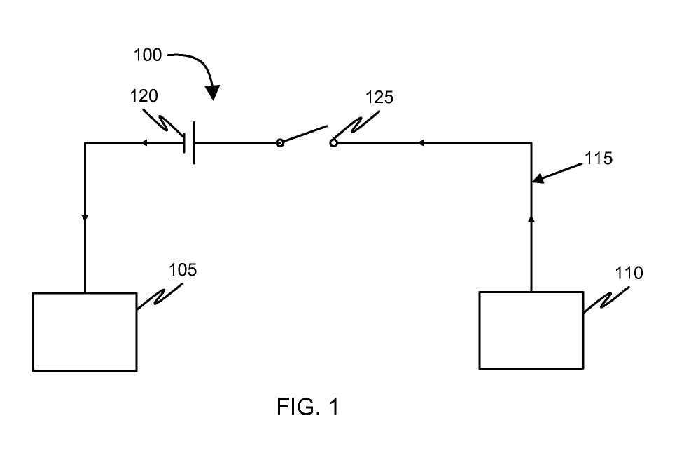

FIG. 1 illustrates an apparatus 100 for braking an electric motor in accordance with an embodiment of the invention. Apparatus 100 includes an electric motor 105, an electric generator 110, and an electrical circuit arrangement 115 capable of connecting electric motor 105 and electric generator 110. For example, electric motor 105 may include for example but not limited to, an alternating current (AC) motor, a direct current (DC) motor, a universal motor, a servo motor and an electrostatic motor. [To Inventors: Please let us know whether an AC motor can be used here.] Electric motor 105 consumes power and a magnetic field to produce rotational torque. Electric motor 105 may include a plurality of magnets that provide magnetic forces for producing the rotational torque. For example, electric motor 105 may include two stationary electromagnets of opposite polarity and a rotating electromagnet that provide magnetic forces. The magnetic forces cause the rotating electromagnet to produce the rotational torque.

Electric motor 105 receives power from a power source 120. In an embodiment, power source 120 may be an energy storage device. In another embodiment, power source 120 may be a direct power source. Power source 120 supplies the power to electric motor 105 through electrical circuit arrangement 115 by establishing a connection. In an embodiment, electrical circuit arrangement 115 may include one or more wires for transmitting power. For example, electrical circuit arrangement 115 includes two wires for supplying the power to electric motor 105. On supplying the power, a motor electromotive force present in electric motor 105 is measured. The motor electromotive force generated in electric motor 105 is an instantaneous motor electromotive force. The motor electromotive force generated needs to be negated to brake electric motor 105. For example, if the instantaneous motor electromotive force is E₁ at time t₁, an instantaneous electromotive force E₂ at time t₂ which is substantially equal in magnitude and opposite in polarity to the instantaneous motor electromotive force E₁, is required to negate the instantaneous motor electromotive force E₁. As the instantaneous electromotive force E₂ is opposite in polarity to the instantaneous motor electromotive force E₁, net electromotive force at electric motor 105 at time t₂ is zero. Therefore, electric motor 105 is braked instantly i.e., at time t₂ without generating friction caused from opposing the direction of rotation of electric motor 105.

To this end, apparatus 100 includes an electric generator 110 capable of generating an instantaneous generator electromotive force for negating the motor electromotive force generated by electric motor 105. The instantaneous generator electromotive force is generated at substantially equal in magnitude and opposite in polarity to the instantaneous motor electromotive force present in electric motor 105. The instantaneous generator electromotive force is generated at one or more output terminals of electric generator 110. Electric generator 110 produces electric current through electromagnetic induction. The electric current is then converted into the instantaneous generator electromotive force.

The instantaneous generator electromotive force is then supplied to electric generator 110 through electrical circuit arrangement 115 capable of connecting electric generator 110 and electric motor 105. Electrical circuit arrangement 115 connects one or more output terminals of electric generator 110 and one or more input terminals of electric motor 105. Thus, the instantaneous generator electromotive force generated at the one or more output terminals of electric generator 110 is supplied to one or more input terminals of electric motor 105. For example, one or more wires connecting the one or more output terminals such as, one or more pins of electric generator 110 transmit the instantaneous generator electromotive force to the one or more input terminals of electric motor 105. This instantaneous generator electromotive force negates the motor electromotive force to brake electric motor 105.

In an embodiment, the instantaneous generator electromotive force may be supplied in response to establishing a connection between electric generator 110 and electric motor 105. Apparatus 100 includes a switch, such as a switch 125 for establishing the connection between electric generator 110 and electric motor 105. Once the connection is established, electrical circuit arrangement 115 is completed. The connection between electric generator 110 and electric motor 105 may be established on actuation of switch 125.

In an embodiment, electrical circuit arrangement 115 is capable of processing the instantaneous generator electromotive force prior to supplying the instantaneous generator electromotive force to electric motor 105. For example, the instantaneous generator electromotive force generated at electric generator 110, such as E₃ may lose magnitude due to frictional losses or due to any other losses experienced within electric motor 105. The instantaneous generator electromotive force E₃ is equal to the instantaneous electromotive force E₂ mentioned in the previous example. Therefore, the instantaneous generator electromotive force E₃ may be reduced by a reduction component “x”, to E₃−X. In this scenario, the instantaneous generator electromotive force E₃ may not be substantially equal in magnitude to the instantaneous motor electromotive force present in electric motor 105, such as E₁.However, it will be readily apparent to a person of ordinary skill in the art that the reduction component “x” may be negligible in magnitude.

In cases where the instantaneous generator electromotive force is reduced, electrical circuit arrangement 115 processes the instantaneous generator electromotive force to be substantially equal in magnitude to the instantaneous motor electromotive force present in electric motor 105. More specifically, the reduced instantaneous generator electromotive force E₃−x is then stepped up to the instantaneous generator electromotive force E₃ which is substantially equal in magnitude and opposite in polarity to the instantaneous motor electromotive force E₁. It will be apparent to a person skilled in the art that the reduced instantaneous generator electromotive force is stepped up using any electrical unit known in the art.

Therefore, the instantaneous generator electromotive force substantially negates the instantaneous motor electromotive force generated by electric motor 105. Consequently, electric motor 105 is braked instantly without generating friction caused by opposing the direction of rotation of electric motor 105. Apparatus 100 may be implemented in one or more of machine tools, robots, vehicles, earth movers, and heavy-duty machines, trains for instant braking without friction. In vehicles and trains, apparatus 100 may be implemented during emergency situations, such as to prevent accidents.

In an embodiment, electric motor 105 is connected to one or more moving members through a shaft (not numbered in FIG. 1). A moving member of the one or more moving members may be part of but not limited to, a machine and a vehicle. Electric motor 105 is capable of driving the one or more moving members. Braking of electric motor 105 causes the one or more moving members to stop instantly. The moving members may be for example but not limited to, robotic arms, wheels and spindle of machines.

Explaining by way of an example, apparatus 100 is implemented in robotic arms for instantly braking movement of the robotic arms without friction. An electric motor driving a robotic arm receives power from a power source via an electrical circuit arrangement. On receiving the power, a motor electromotive force present in the electric motor is measured. The motor electromotive force generated in the electric motor is an instantaneous motor electromotive force. The instantaneous motor electromotive force needs to be reflected to brake the electric motor. Apparatus 100 includes an electric generator for generating an instantaneous generator electromotive force at substantially equal in magnitude and opposite in polarity to the instantaneous motor electromotive force present in the electric motor. This instantaneous generator electromotive force substantially negates the instantaneous motor electromotive force generated by the electric motor. Thus, the substantial reflection of the instantaneous motor electromotive force instantly brakes the movement of the robotic arm without friction.

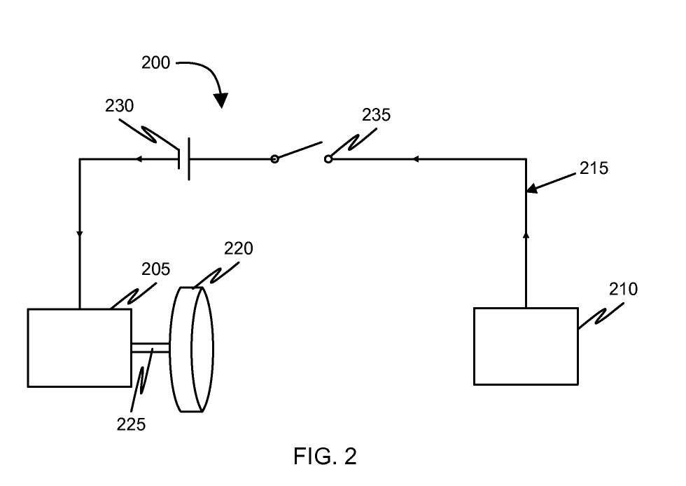

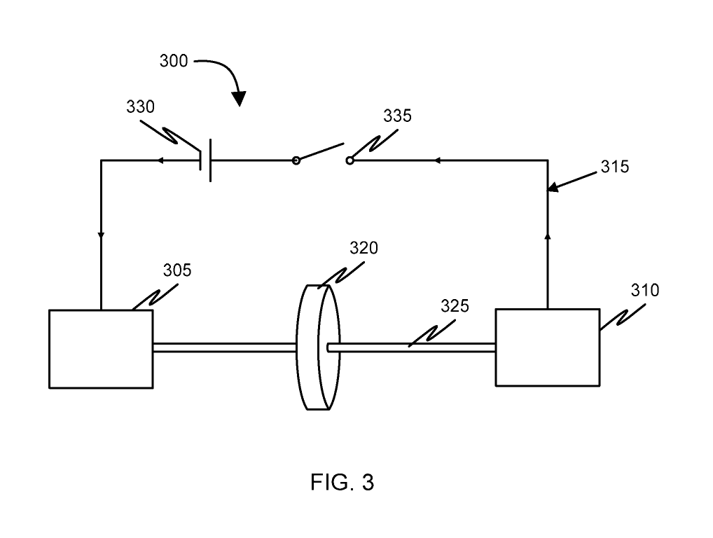

In another example, apparatus 100 is implemented in a vehicle for rapidly braking movement of the vehicle. An electric motor is used to drive the one or more wheels. The electric motor receives power from a power source via an electrical circuit arrangement. On receiving the power, a motor electromotive force present in the electric motor is measured. The motor electromotive force generated in the electric motor is an instantaneous motor electromotive force. The instantaneous motor electromotive force needs to be negated to brake the electric motor. This is achieved using an electric generator. The electric generator generates an instantaneous generator electromotive force at substantially equal in magnitude and opposite in polarity to the instantaneous motor electromotive force present in the electric motor. This instantaneous generator electromotive force substantially negates the instantaneous motor electromotive force. Thus, the vehicle is rapidly stopped. For example, when a pedestrian or an animal suddenly crosses a path of the vehicle, apparatus 100 may be implemented in the vehicle for rapidly braking the movement of the vehicle, thereby preventing an accident during such emergency situations. The braking of the movement of the vehicle is explained in detail in conjunction with FIG. 2 and FIG. 3.

Moving now to FIG. 2, a system 200 for braking an electric motor connected to one or more wheels mounted on an axle of a vehicle is illustrated in accordance with an embodiment of the invention. System 200 may be, for example implemented in a vehicle with four wheels that needs to be instantly braked without friction. However, the vehicle may be but not limited to, a two-wheeled vehicle, a three-wheeled vehicle and a four-wheeled vehicle. System 200 includes an electric motor 205, an electric generator 210 and an electrical circuit arrangement 215. Electric motor 205 is used for driving one or more wheels 220-n. For example, electric motor 205 is connected a wheel 220 connected to axle 225 for driving wheel 220. Electric motor 205 receives power from a power source 230. Power source 230 supplies the power to electric motor 205 via electrical circuit arrangement 215. This is explained in conjunction with FIG. 1. On supplying the power, a motor electromotive force is generated in electric motor 205 for driving one or more wheels 220-n. To brake one or more wheels 220-n, electric motor 205 is stopped using electric generator 210.

Electric generator 210 is capable of generating an instantaneous generator electromotive force. The instantaneous generator electromotive force is generated at substantially equal in magnitude and opposite in polarity to the instantaneous motor electromotive force. The instantaneous generator electromotive force is generated at one or more output terminals of electric generator 210. It would be readily apparent to a person of ordinary skill in the art that electric generator 210 may be positioned anywhere within system 200.

Electrical circuit arrangement 215 is capable of connecting electric generator 210 to electric motor 205. The instantaneouss generator electromotive force generated at the one or more output terminals of electric generator 210 is supplied to one or more input terminals of electric motor 205. The instantaneous generator electromotive force is supplied in response to connecting electric generator 210 and electric motor 205. In an embodiment, a connection between electric generator 210 and electric motor 205 may be established in response to actuation of a switch, such as a switch 235. More specifically, electrical circuit arrangement 215 connects electric generator 210 and electric motor 205 when switch 235 is actuated. Thereafter, the instantaneous generator electromotive force is supplied to electric motor 205 to substantially negate the instantaneous motor electromotive force. As a result, one or more wheels 220-n stop instantly without generating friction caused by opposing the direction of rotation of one or more wheels 220-n.

In an embodiment, electrical circuit arrangement 215 may be capable of processing the instantaneous generator electromotive force prior to supplying the instantaneous generator electromotive force to electric motor 205. This is performed because there may be loss in magnitude of the instantaneous generator electromotive force due to frictional losses or due to any other losses experienced within electric motor 105. This is explained in conjunction with FIG. 1.

In an embodiment, a vehicle may include one or more systems similar to system 200. Each system may include an electric motor, an electric generator, and an electrical circuit arrangement. For example, a system such as, system 200 may be connected to each wheel of a car. In this case, an electric motor may be connected to each wheel of the four wheels of the car. In an embodiment, single electric generator may supply an instantaneous generator electromotive force to each electric motor for braking the wheels. Alternatively, a system may include four generators. Each generator may supply instantaneous generator electromotive force to a motor connected to a corresponding wheel of the car for stopping the car.

In this embodiment as described in FIG. 2, electric generator 210 supplying the instantaneous generator electromotive force to electric motor 205 may not be driven by electric motor 205. However, in other embodiments, such as an embodiment illustrated in FIG. 3 an electric generator supplying an instantaneous generator electromotive force to an electric motor is driven directly by the electric motor.

FIG. 3 illustrates a system 300 for braking an electric motor connected to one or more wheels mounted on an axle in accordance with another embodiment of the invention. System 300 may be for example a vehicle such as, but not limited to a two-wheeled vehicle, a three-wheeled vehicle, a four-wheeled vehicle and a multi-wheeled vehicle. System 300 includes an electric motor 305, an electric generator 310 and an electrical circuit arrangement 315. Electric motor 305 is connected to one or more wheels 320-n mounted on axle 325 for driving one or more wheels 320-n. Electric motor 305 receives power from a power source 330. Power source 330 supplies the power to electric motor 305 via electrical circuit arrangement 315.

Electric generator 310 is capable of generating an instantaneous generator electromotive force. The instantaneous generator electromotive force is generated at substantially equal in magnitude and opposite in polarity to the instantaneous motor electromotive force present in electric motor 305. In this embodiment, electric generator 310 is driven directly by electric motor 305. Electric motor 305 may be connected to a first end of axle 325 of the electric vehicle, whereas electric generator 310 may be connected to a second end of axle 325. Therefore, electric generator 310 rotates at an angular velocity that is equal to an angular velocity of electric motor 305. The rotation of electric generator 310 at an angular velocity equal to the angular velocity of rotation of electric motor 305 allows electric generator 310 to generate the instantaneous generator electromotive force. This similarity of angular velocity results in generation of the instantaneous generator electromotive force at substantially equal in magnitude and opposite in polarity to the instantaneous motor electromotive force present in electric motor 305.

In an alternative embodiment, electric generator 310 may be placed above electric motor 305. Thus, the rotational torque produced by electric motor 305 may be transmitted to electric generator 310 using any transmission transferring arrangement. The transmission transferring arrangement, may be for example, but not limited to a gear arrangement and a pulley arrangement.

The instantaneous generator electromotive force generated by electric generator 310 is then supplied to electric motor 305 via electrical circuit arrangement 315. The instantaneous generator electromotive force is supplied when a connection is established between electric generator 310 and electric motor 305 using electrical circuit arrangement 315. In an embodiment, the connection may be established by actuating a switch, such as a switch 335. This is explained in conjunction with FIG. 1 and FIG. 2.

In an embodiment, electrical circuit arrangement 315 is capable of processing the instantaneous generator electromotive force prior to supplying the instantaneous generator electromotive force to electric motor 305. For example, the instantaneous generator electromotive force generated at electric generator 310 may lose magnitude due to frictional losses. Therefore, the instantaneous generator electromotive force may not be substantially equal in magnitude to the instantaneous motor electromotive force. In such cases, electrical circuit arrangement 315 processes the instantaneous generator electromotive force to be substantially equal in magnitude to the instantaneous motor electromotive force present in electric motor 305. The reduced instantaneous generator electromotive force is then stepped up to the instantaneous generator electromotive force, which is substantially equal in magnitude and opposite in polarity to the instantaneous motor electromotive force. This is explained in conjunction with FIG. 2.

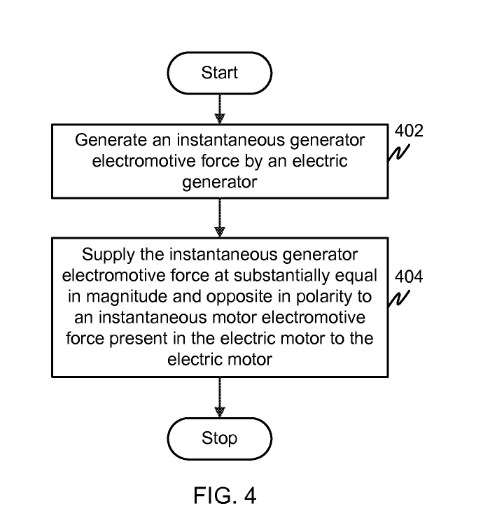

FIG. 4 is a flowchart of a method of braking an electric motor, for example electric motor 105 in accordance with an embodiment of the invention. The electric motor receives power from a power source. On receiving the power, motor electromotive force present in the electric motor is measured and is noted as an instantaneous motor electromotive force. In step 402, an electric generator, for example electric generator 120 generates an instantaneous generator electromotive force. The instantaneous generator electromotive force may be generated at the one or more output terminals of the electric generator. The instantaneous generator electromotive force is generated at substantially equal in magnitude and opposite in polarity to the instantaneous motor electromotive force present in the electric motor. The process of generating the instantaneous generator electromotive force is described in further detail in conjunction with FIG. 1 and FIG. 2.

Thereafter, at step 404 the instantaneous generator electromotive force is supplied to the electric motor via an electrical circuit arrangement by establishing a connection. The instantaneous generator electromotive force generated at the one or more output terminals of the electric generator is supplied to one or more input terminals of the electric motor. The process of supplying the instantaneous generator electromotive force is described in conjunction with FIG. 1 and FIG. 2. In an embodiment, the connection between the electric generator and the electric motor may be established upon actuation of a switch. The instantaneous generator electromotive force substantially negates the instantaneous motor electromotive force generated by the electric motor. Due to reflection of the instantaneous motor electromotive force, the electric motor is stopped instantly.

Various embodiments of the invention provide a method and apparatus for braking an electric motor. The apparatus includes an electric motor, an electric generator, and an electrical circuit arrangement capable of connecting the electric generator to the electric motor. The electric generator generates an instantaneous generator electromotive force at substantially equal magnitude and opposite polarity to an instantaneous motor electromotive force present in the electric motor. Therefore, the instantaneous generator electromotive force brakes the electric motor instantly without generating friction caused from opposing the direction of rotation of the electric motor. The apparatus may be implemented in one or more of machine tools, robotic arms, hybrid electric vehicles, earth movers, heavy-duty machines, and trains. for instant braking without friction.

Those skilled in the art will realize that the above recognized advantages and other advantages described herein are merely exemplary and are not meant to be a complete rendering of all of the advantages of the various embodiments of the present invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An apparatus comprising:
an electric motor;
an electric generator for generating an instantaneous generator electromotive force; and
an electrical circuit arrangement capable of connecting the electric generator to the electric motor, wherein the electrical circuit arrangement is capable of supplying the instantaneous generator electromotive force at substantially equal in magnitude and opposite in polarity to an instantaneous motor electromotive force present in the electric motor to the electric motor, the instantaneous generator electromotive force is being supplied in response to connecting the electric generator and the electric motor;
whereby, the instantaneous generator electromotive force substantially negates the instantaneous motor electromotive force, thereby braking the electric motor.

2. The apparatus of claim 1, wherein the electric generator is driven by the electric motor.

3. The apparatus of claim 1, wherein the instantaneous generator electromotive force is generated at least one output terminal of the electric generator.

4. The apparatus of claim 3, wherein the instantaneous generator electromotive force generated at the at least one output terminal of the electric generator is supplied to at least one input terminal of the electric motor.

5. The apparatus of claim 1, wherein the electric motor is connected to at least one moving member through a shaft, the electric motor capable of driving the at least one moving member.

6. The apparatus of claim 5, wherein a moving member of the at least one moving member is of one of a machine and a vehicle.

7. The apparatus of claim 5 further comprising a switch for braking the at least one moving member upon actuation, wherein the instantaneous generator electromotive force is supplied to the electric motor in response to actuation of the switch.

8. The apparatus of claim 1, wherein the electric motor is connected to a first end of an axle of a vehicle connected to at least one wheel for driving the at least one wheel.

9. The apparatus of claim 8, wherein the electric generator is connected to a second end of the axle.

10. The apparatus of claim 1 further comprising a power source for supplying at least one of voltage, current and power to the electric generator based on at least one of a voltage, current and power generated by the electric motor.

11. The apparatus of claim 1, wherein the electrical circuit arrangement is capable of processing the instantaneous generator electromotive force prior to supplying the instantaneous generator electromotive force to the electric motor.

12. A system comprising;
at least one wheel;
an electric motor connected to the at least one wheel for driving the at least one wheel;
an electric generator capable of generating an instantaneous generator electromotive force at substantially equal in magnitude and opposite in polarity to an instantaneous motor electromotive force present in the electric motor; and
an electrical circuit arrangement capable of connecting the electric generator to the electric motor, wherein the electrical circuit arrangement is capable of supplying the instantaneous generator electromotive force to an instantaneous motor electromotive force present in the electric motor to the electric motor, the instantaneous generator electromotive force is being supplied in response to connecting the electric generator and the electric motor;
whereby, the instantaneous generator electromotive force generated by the electric generator substantially negates the instantaneous motor electromotive force, thereby braking the at least one wheel.

13. The system of claim 12 further comprising a shaft, wherein the at least one wheel is mounted on the shaft.

14. The system of claim 13, wherein the shaft comprises:
a first end connected to the electric motor; and
a second end connected to the electric generator.

15. The system of claim 14, wherein the shaft is an axle of a vehicle.

16. The system of claim 12 further comprising a switch for braking the at least one wheel upon actuating, wherein the instantaneous generator electromotive force is supplied to the electric motor in response to actuation of the switch.

17. The system of claim 12, wherein the electric generator is driven by the electric motor.

18. The system of claim 12, wherein the instantaneous generator electromotive force is generated at least one output terminal of the electric generator.

19. The system of claim 18, wherein the instantaneous generator electromotive force generated at the at least one output terminal of the electric generator is supplied to at least one input terminal of the electric motor.

20. The system of claim 12 further comprising a power source for supplying at least one of voltage, current and power to the electric generator based on at least one of a voltage, current and power generated by the electric motor.

21. The system of claim 12, wherein the electrical circuit arrangement is capable of processing the instantaneous generator electromotive force prior to supplying the instantaneous generator electromotive force to the electric motor.

22. A method of braking an electric motor, the method comprising:
generating an instantaneous generator electromotive force by an electric generator; and
supplying the instantaneous generator electromotive force at substantially equal in magnitude and opposite in polarity to an instantaneous motor electromotive force present in the electric motor to the electric motor;
whereby the instantaneous generator electromotive force generated using the electric generator substantially negates the instantaneous motor electromotive force present in the electric motor, thereby braking the electric motor.

23. The method of claim 22 further comprising actuating a switch for braking the electric motor, wherein the instantaneous generator electromotive force is supplied to the electric motor in response to actuating the switch.
